(19) United States
(12) Patent Application Publication
(10) Pub. No.: US 2008/0186481 A1
(43) Pub. Date: Aug. 7, 2008

(54) Optical vision inspection apparatus

(76) Inventor: Chien-Lung Chen, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/702,497

(22) Filed: Feb. 6, 2007

(51) Int. Cl. G01N 21/00

(52) U.S. Cl. 356/237.1

(57) ABSTRACT

The present invention discloses an optical vision inspection apparatus, wherein the light supply unit thereof includes a light source base having a concaved surface and a plurality of light-emitting elements providing shorter-wavelength light. The concaved surface can focuses the light emitted by the light-emitting elements onto the surface of the inspected object. In comparison with blue light or red light used in the conventional technology, the shorter-wavelength light has a higher energy. Therefore, in the present invention, the light signal receiving unit receives more intense light signals. Thus, no matter what type of defect there is, the succeeding signal-processing unit has more reliable light signals, and the result of defect inspection is more accurate.

### BACKGROUND OF THE INVENTION

1. Field of the Invention

The present invention relates to an inspection apparatus, particularly to an optical vision inspection apparatus.

2. Description of the Related Art

To promote quality and reduce cost, the defective elements should be found out and then repaired/rejected before the fabrication process ends. However, naked-eye inspection can no more meet the trend of fast fabricating large-scale and fine-line elements in the electronic and optoelectronic industries. In addition to electric performance test, the inspection of appearance and surface defects is also an important inspection item, and AOI (Automatic Optical Inspection) is a technology to inspect the appearance and surface defects of electronic elements. AOI not only can implement the quality control of finished products but also can aid the monitoring of semi-products, and errors can thus be forward amended.

The common surface defects of electronic elements include dirt, dust, foreign matters, scratches, bubbles, cracked corners, and folded marks. Limited by the characteristics of the light source and the sensing range of CCD (Couple Charged Device), an AOI machine can usually inspect only few types of the defects mentioned above. An AOI machine generally adopts a light source according to various factors, such as the characteristics of the inspected object and the CCD used by the machine. As the frequency response of the current industrial CCD is between 300 and 700 nm, an AOI machine usually adopts a visible light source having a wavelength of between 470 and 680 nm. Refer to FIG. 1(A) and FIG. 1(B) for the conventional AOI machines. In FIG. 1(A), the machine only has a single light source 10. The light source 10 has a plurality of light-emitting elements 101 emitting blue light with a wavelength of about 450 nm. The light source 10 is arranged below a carry disc 12 which carries an inspected object 13. A CCD device 14 is also arranged below the inspected object 13 and used to receive the light signal reflected from the surface illuminated by the light source 10 for defect analysis, wherein the incident light is denoted by arrows with a solid line, and the reflected light is denoted by arrows with a dashed line. In FIG. 1(A), no matter whether the inspected object 13 is transparent or not, only a single surface can be inspected in one inspection operation. In FIG. 1(B), the machine has a first light source 10 and a second light source 11 which illuminate a transparent inspected object 13. Thus, both sides of the inspected object 13 can be simultaneously inspected. The first light source 10 is arranged between the inspected object 13 and the CCD device 14. The first light source 10 has a plurality of light-emitting elements 101 emitting blue light with a wavelength of about 450 nm. The second light source 11 is arranged below the inspected object 13 and at a position corresponding to the first light source 10. The second light source 10 has a plurality of light-emitting elements 111 emitting red light with a wavelength of about 600 nm. Blue light has a better reflection capability, and red light has a better penetration capability; thus, the defects on both sides of the inspected object 13 can be simultaneously detected by the CCD device 14. However, the structures of the light sources of the abovementioned AOI machines cannot concentrate light onto the inspected surface. Therefore, the light signal received by the CCD device 14 is pretty weak.

The abovementioned two AOI machines are the common examples of the optical inspection technology. The positions of the CCD device, the inspected object and the light sources can be adjusted to achieve a better inspection result. No matter what structure the optical inspection machine has, the light source thereof is usually red light, blue light, or the combination of red and blue lights. However, both red light and blue light have longer wavelengths and lower energies. Many light-projection methods have been developed to solve the problem of insufficient energy, such as forward light projection, backward light projection, and structural light projection, but these designs usually bring about complicated optical inspection structures and longer optical paths. After traveling through a long optical path and being absorbed by the inspected object, the reflected or refracted light signal the CCD device receives is pretty weak and hard to analyze, and some tiny defects are thus unlikely to detect.

Accordingly, the present invention proposes an optical vision inspection apparatus to solve the abovementioned problems, wherein higher energy light sources are used to intensify light signals and promote inspection accuracy.

### SUMMARY OF THE INVENTION

The primary objective of the present invention is to provide an optical vision inspection apparatus, wherein the shorter-wavelength light-emitting elements are specially arranged to have more intense light energy focused onto the surface of the inspected object, and tiny surface defects can thus be easily detected.

Another objective of the present invention is to provide an optical vision inspection apparatus, wherein the relative position of the light supply unit and the light signal receiving unit can be adjusted to enable the inspection of transparent objects and opaque objects.

To achieve the abovementioned objectives, the present invention proposes an optical vision inspection apparatus, which comprises at least one light supply unit, at least one inspection table, at least one light signal receiving unit and at least one signal-processing unit. The light supply unit further comprises a light source base and a plurality of light-emitting elements. The light emitted by the light-emitting element has a shorter wavelength of between 370 and 400 nm. The light source base has at least one concaved surface. The light-emitting elements are arranged on the concaved surface and function as light sources. The concaved surface has a slope angle of between 5 and 30 degrees. Thereby, the light emitted by the light-emitting elements is concentrated onto the surface of the inspected object placed on the inspection table. The incident light is reflected to become a plurality of reflective-light signals or refracted to become a plurality of transmissive-light signals. The light signal receiving unit receives the reflective-light signals and the transmissive-light signals and transfers them to the signal-processing unit for the analysis of the surface defects of the inspected object. Via the concaved surface and the shorter-wavelength light source, the surface of the inspected object can has a given amount of incident light energy. Thus, the reflective-light signals or the transmissive-light signals also maintain at a given intensity. Accordingly, the optical vision inspection apparatus of the present invention can promote the overall detection accuracy.

To enable the objectives, technical contents, characteristics and accomplishments of the present invention, the embodiments of the present invention are to be described in cooperation with the attached drawings below.

### BRIEF DESCRIPTION OF THE DRAWINGS

FIG. 1(A) is a diagram schematically showing the structure of a conventional optical inspection machine with a single light source;

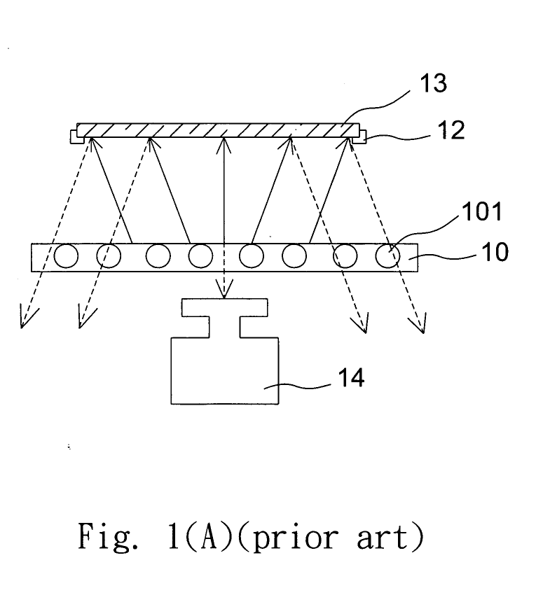

FIG. 1(B) is a diagram schematically showing the structure of a conventional optical inspection machine with dual light sources;

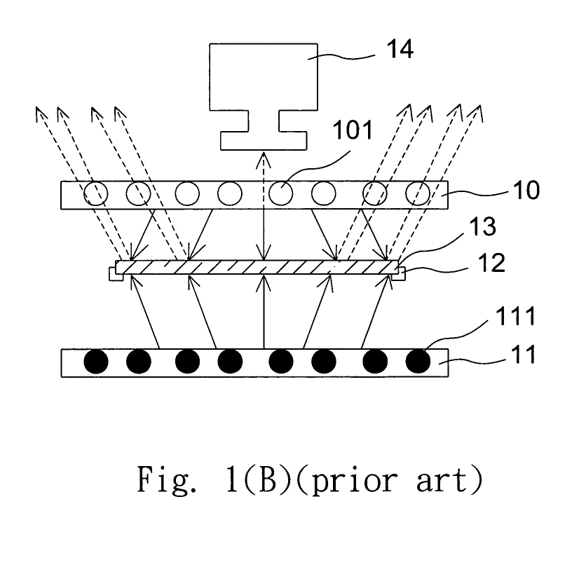

FIG. 2 is a diagram schematically showing the structure according to a first embodiment of the present invention;

FIG. 3 is a diagram schematically showing the structure according to a second embodiment of the present invention;

FIG. 4(A) is a sectional view schematically showing the light supply unit according to the present invention;

FIG. 4(B) is a perspective view schematically showing the light supply unit according to the present invention; and

FIG. 5 is a diagram schematically showing the structure according to a third embodiment of the present invention.

### DETAILED DESCRIPTION OF THE INVENTION

An effective, stable and accurate light source is a critical factor in inspecting the appearance and the surface defects of an object. Thus, the present invention proposes an optical vision inspection apparatus. The related principles and the embodiments of the present invention are to be described in cooperation with the drawings below.

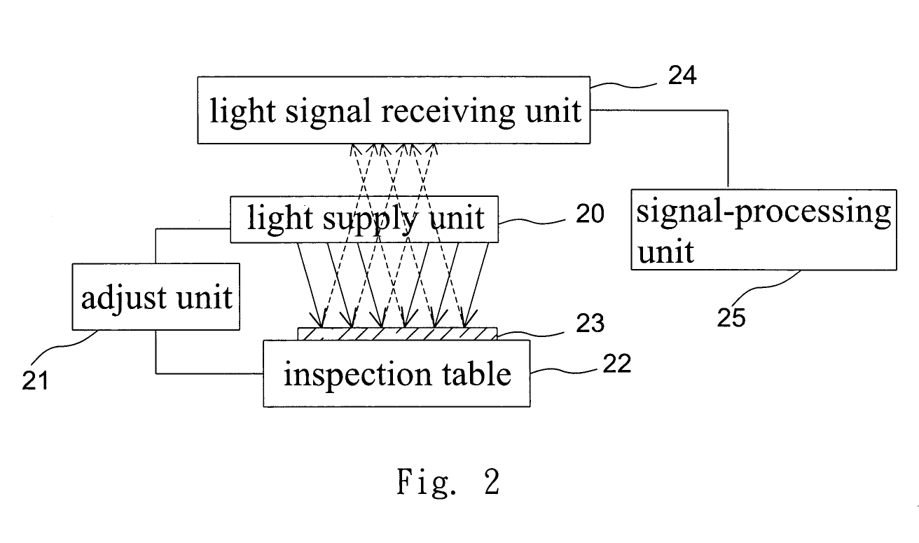

According to classic physics, the reactions between the inspected object and the incident light include reflection, refraction, transmission and absorption, which are respectively associated with reflectivity, refractivity, transmissivity and absorptivity. Refractivity not only correlates with the physical properties of the inspected object but also with the wavelength of the incident light. For an identical optical glass, the refractivity of green light is higher than that of red light, and the refractivity of blue light is higher than that of green light. Refer to FIG. 2 a diagram schematically showing the structure according to a first embodiment of the present invention. In FIG. 2, the inspected object 23 is an opaque object, such as a semiconductor substrate, a printed circuit board, a substrate coated with an opaque material, or the like. The inspected surface of the inspected object 23 placed on an inspection table 22 receives the light coming from a light supply unit 20. In FIG. 2, the arrows with a solid line are used to indicate the propagation direction of the incident light. The inspection table 22, the light supply unit 20, or both of them are coupled to an adjust unit 21. The adjust unit 21 adjusts the distance between the light supply unit 20 and the inspection table 22 according to the related parameters, such as the thickness of the inspected object, the position of the inspected object, the type of the light source, etc. Thereby, the light coming from the light supply unit 20 can focus on the inspected surface of the inspected object 23, and the inspected surface can have a given intensity of light energy. As the inspected object 23 is opaque, most of the incident light is absorbed or reflected. A light signal receiving unit 24 receives the light reflected by the inspected object 23, and the reflective-light signals are indicated by the arrows with a dashed line. A signal-processing unit 25 processes and analyzes the reflective-light signals. As the light signals are reflected from the inspected object 23, the light supply unit 20 and the light signal receiving unit 24 are arranged on the same side of the inspected object 23.

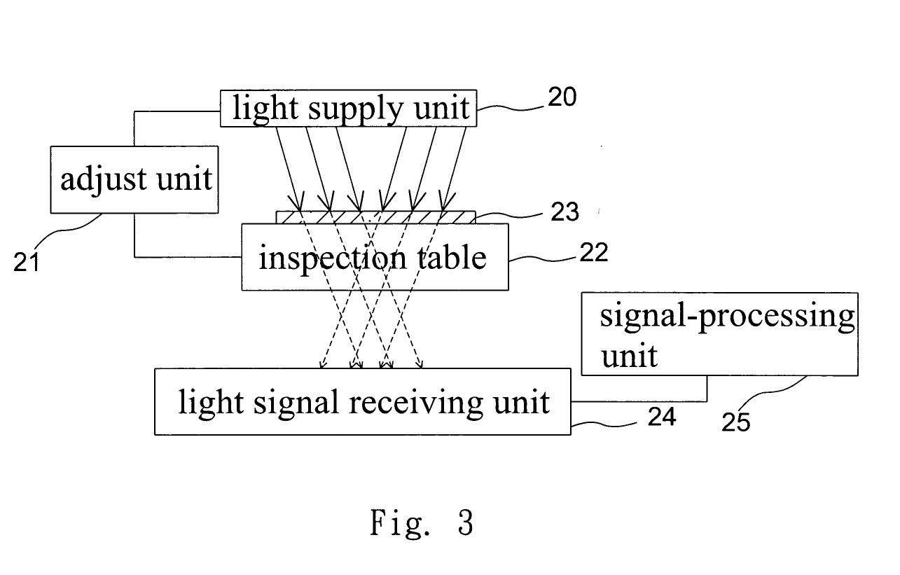

Refer to FIG. 3 a diagram schematically showing the structure according to a second embodiment of the present invention. Besides opaque objects, the inspected object may be a transparent one in this embodiment, such as that made of optical glass, quartz, or the like, and the structure of the inspection apparatus is different from that of the first embodiment. Similarly to the first embodiment, there is also a light supply unit 20 providing light for the inspected surface of the inspected object 23. As the inspected object 23 is transparent, most of the incident light is absorbed or penetrates. As the light signals in the second embodiment are mainly transmissive-light signals, the light supply unit 20 and the light signal receiving unit 24 are respectively arranged on different sides of the inspected object 23.

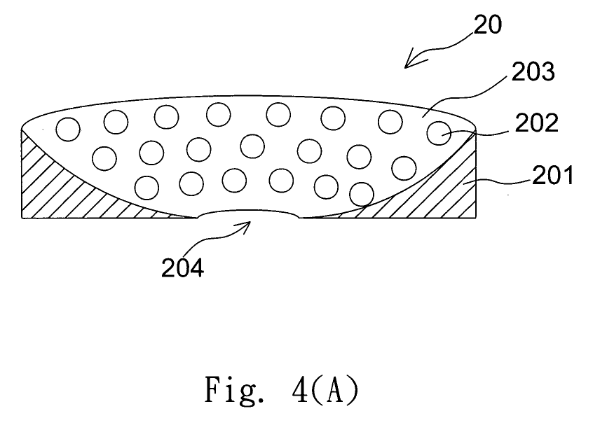

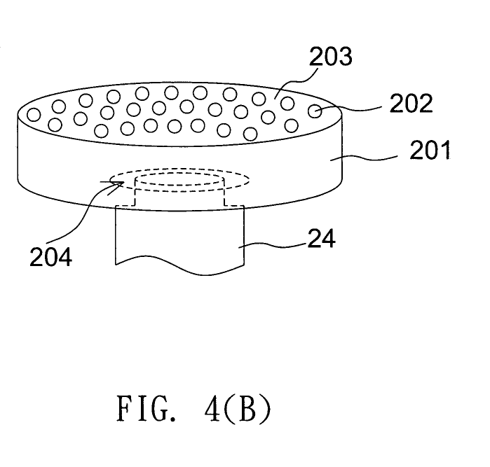

Refer to FIG. 4(A) a sectional view schematically showing the light supply unit according to the present invention, and refer to FIG. 4(B) a perspective view schematically showing the light supply unit according to the present invention. In either of the optical vision inspection apparatuses disclosed in FIG. 2 and FIG. 3, the light supply unit 20 has a light source base 201 and a plurality of light-emitting elements 202. For providing a higher energy, the light-emitting elements 202 emits light having a shorter wavelength of between 370 and 400 nm. The light-emitting element 202 may be realized by a light-emitting diode, a cold cathode fluorescent lamp, an organic electroluminescent element, or the like. In the abovementioned embodiments of the present invention, the light source base 201 has an obconical concaved surface 203, and the light-emitting elements 202 are arranged on the concaved surface 203. The slope angle of the concaved surface 203 is designed to focus light onto the inspected surface of the inspected object. Besides the obconical shape in these embodiments, the concaved surface 203 may have other forms, such as a rectangle, an inverted pyramid, a sphere, etc., to meet different inspected items or different mechanical designs. The concaved surface 203 may have an opening 204 used to accommodate the light signal receiving unit 24. In addition to an ordered array, the light-emitting elements 202 may also be randomly arranged for the inspection of different defects.

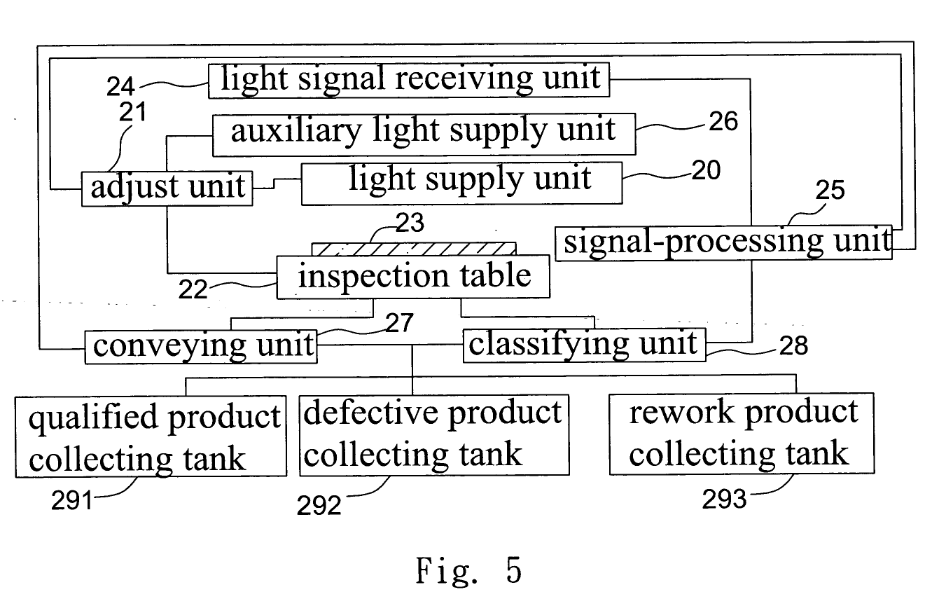

Refer to FIG. 5 a diagram schematically showing the structure according to a third embodiment of the present invention. In the third embodiment, the optical vision inspection apparatus further has a qualified product collecting tank 291, a defective product collecting tank 292 and a rework product collecting tank 293. In this embodiment, a conveying unit 27 transports the objects to be inspected to the inspection table 22; the light supply unit 20 provides light for the inspected surface of the inspected object 23; the light signal receiving unit 24 receives the signals from the inspected object 23 and transmits the signals to the signal-processing unit 25; if the signal-processing unit 25 determines the inspected object 23 to be a qualified product after processing and analyzing the signals, a classifying unit 28 distributes the qualified product to the qualified product collecting tank 291 to wait for the succeeding fabrication step; if the signal-processing unit 25 determines the inspected object 23 to be a defective product after processing and analyzing the signals, the classifying unit 28 distributes the defective product to the defective product collecting tank 292 for returning the defective products; if the signal-processing unit 25 determines the inspected object 23 to be a product needing reworking after processing and analyzing the signals, the classifying unit 28 distributes the product needing reworking to the rework product collecting tank 293 for reworking.

The abovementioned light signal receiving unit can be implemented with charge coupled devices. The optical vision inspection apparatus of the present invention may adopt different types of inspection tables, such as a partition rotary disc or an X-Y carry table, to meet different inspected objects. Further, a vacuum device or a clamp device may be used to fix the inspected object firmly on the inspection table so that the light supply unit can stably project light on the inspected surface of the inspected object. Besides, an extra auxiliary light supply unit may be used to assist in the inspection according to the features of the inspected object. For example, an auxiliary light supply unit may be installed at the same side of the light supply unit to enhance the intensity of the light reflected from an opaque inspected object, wherein the light sources of the auxiliary light supply unit may adopt the light-emitting elements similar to those used in the light supply unit. To enhance the intensity of the light penetrating a transparent inspected object, an auxiliary light supply unit may also be installed at the same side of the light supply unit; however, in this case, the light-emitting elements of the auxiliary light supply unit are mainly those having a high penetration capability. For simultaneously detecting both surfaces of an inspected object, two light supply units are respectively installed on two sides of the inspected object. The light source design and the architecture thereof disclosed in the present invention can apply to various optical vision inspection apparatuses. However, the practical structures thereof are influenced by many factors. Thus, the detail of them will not be further described herein.

In summary, as the optical vision inspection apparatus of the present invention adopts light-emitting elements emitting a shorter-wavelength light and a light source base having a special concaved structure, light can focus onto the inspected surface of the inspected object, and the probability of detecting the defects on the inspected surface is promoted.

Those described above are the embodiments to demonstrate the technical thought and characteristics of the present invention to enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. An optical vision inspection apparatus, comprising the following components:
at least one light supply unit further comprising:
a light source base having at least one concaved surface; and
a plurality of light-emitting elements arranged on said concaved surface and providing short-wavelength light;
at least one inspection table used to carry at least one inspected objects, wherein said inspected objects receives lights coming from said light supply unit and generating a plurality of corresponding light signals;
at least one light signal receiving unit receiving said light signals generated by said inspected objects on said inspection table; and
at least one signal-processing unit analyzing said light signals to detect defects on at least one surface of said inspected objects.

2. The optical vision inspection apparatus according to claim 1, wherein the slope angle of said concaved surface is between 5 and 30 degrees.

3. The optical vision inspection apparatus according to claim 1, wherein the wavelength of lights emitted by said light-emitting element is between 370 and 400 nm.

4. The optical vision inspection apparatus according to claim 1, wherein said light-emitting element is a light-emitting diode, a cold cathode fluorescent lamp or an organic electroluminescent element.

5. The optical vision inspection apparatus according to claim 1, wherein said inspected object is a transparency one or an opaque.

6. The optical vision inspection apparatus according to claim 1, wherein said light signal receiving unit and said light supply unit are arranged on the same side of said inspection table.

7. The optical vision inspection apparatus according to claim 1, wherein said light signal receiving unit and said light supply unit are arranged on different sides of said inspection table.

8. The optical vision inspection apparatus according to claim 1, further comprising at least one adjust unit, wherein said adjust unit is coupled to said light supply unit or coupled to said inspection table or coupled to both said light supply unit and said inspection table.

9. The optical vision inspection apparatus according to claim 1, further comprising at least one auxiliary light supply unit.

10. The optical vision inspection apparatus according to claim 1, wherein said inspection table is a partition rotary disc or an X-Y carry table.

11. The optical vision inspection apparatus according to claim 1, wherein said inspection table is coupled to a conveying unit.

12. The optical vision inspection apparatus according to claim 11, wherein said conveying unit is further coupled to a classifying unit.

13. The optical vision inspection apparatus according to claim 12, wherein said signal-processing unit simultaneously controls said conveying unit and said classifying unit.

14. The optical vision inspection apparatus according to claim 12, wherein when said signal-processing unit determines one inspected object to be a qualified product, said classifying unit distributes said qualified product to a qualified product collecting unit.

15. The optical vision inspection apparatus according to claim 12, wherein when said signal-processing unit determines one inspected object to be a defective product, said classifying unit distributes said defective product to a defective product collecting unit.

16. The optical vision inspection apparatus according to claim 12, wherein when said signal-processing unit determines that one inspected object needs reworking, said classifying unit distributes said object needing reworking to a rework product collecting unit.

17. A light supply device, applying to an optical vision inspection apparatus and comprising the following components:
a light source base having at least one concaved surface; and
a plurality of light-emitting elements arranged on said concaved surface and providing short-wavelength light.

18. A light supply device according to claim 17, wherein the slope angle of said concaved surface is between 5 and 30 degrees.

19. A light supply device according to claim 17, wherein the wavelength of lights emitted by said light-emitting element is between 370 and 400 nm.

20. A light supply device according to claim 17, wherein said light-emitting element is a light-emitting diode, a cold cathode fluorescent lamp or an organic electroluminescent element.
